(19) United States
(12) Patent Application Publication
(10) Pub. No.: US 2019/0062030 A1
(43) Pub. Date: Feb. 28, 2019

(54) Container Closure Assembly

(71) Applicant: Babajide Olumide, Richmond, TX (US)

(72) Inventor: Babajide Olumide, Richmond, TX (US)

(21) Appl. No.: 15/688,988

(22) Filed: Aug. 29, 2017

(51) Int. Cl. B65D 81/20; B65D 51/16; B65D 79/00; F16K 1/30

(52) U.S. Cl. CPC B65D 81/2038; B65D 81/2023; F16K 1/30; B65D 51/1644; B65D 79/005; B65D 51/1661

(57) ABSTRACT

A container closure assembly for vacuum sealing of bottles and containers includes a cylinder that is resilient. A bore is axially positioned through the cylinder. The bore is tapered so that it is circumferentially larger proximate to a bottom of the cylinder. The bore is configured to insert a mouth of a container. The cylinder is configured to abut a lip of the container to sealably couple to the lip of the container. A regulator is selectively couplable to a top of the cylinder. The regulator is configured to selectively sealably close the bore and to selectively motivate air through the bore. The regulator is configured to extract the air through the bore to partially evacuate the container to couple the cylinder to the container. The regulator also is configured to inject the air through the bore to pressurize the container to decouple the cylinder from the container.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2)Description of Related Art including information disclosed under 37 CFR 1.97 and 1.98

The disclosure and prior art relates to closure assemblies and more particularly pertains to a new closure assembly for vacuum sealing of bottles and containers.

### BRIEF SUMMARY OF THE INVENTION

An embodiment of the disclosure meets the needs presented above by generally comprising a cylinder that is resilient. A bore is axially positioned through the cylinder. The bore is tapered so that it is circumferentially larger proximate to a bottom of the cylinder. The bore is configured to insert a mouth of a container. The cylinder is configured to abut a lip of the container to sealably couple to the lip of the container. A regulator is selectively couplable to a top of the cylinder. The regulator is configured to selectively sealably close the bore and to selectively motivate air through the bore. The regulator is configured to extract the air through the bore to partially evacuate the container to couple the cylinder to the container. The regulator also is configured to inject the air through the bore to pressurize the container to decouple the cylinder from the container.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a container closure assembly according to an embodiment of the disclosure.

FIG. 2 is an exploded view of an embodiment of the disclosure.

FIG. 3 is an isometric perspective view of an embodiment of the disclosure.

FIG. 4 is an exploded view of an embodiment of the disclosure.

FIG. 5 is a cross-sectional view of an embodiment of the disclosure.

### DETAILED DESCRIPTION OF THE INVENTION

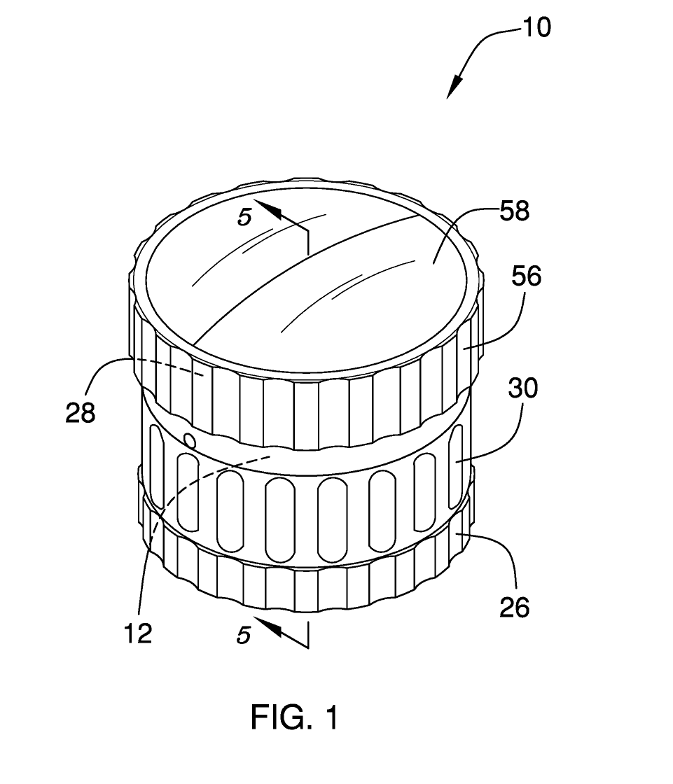

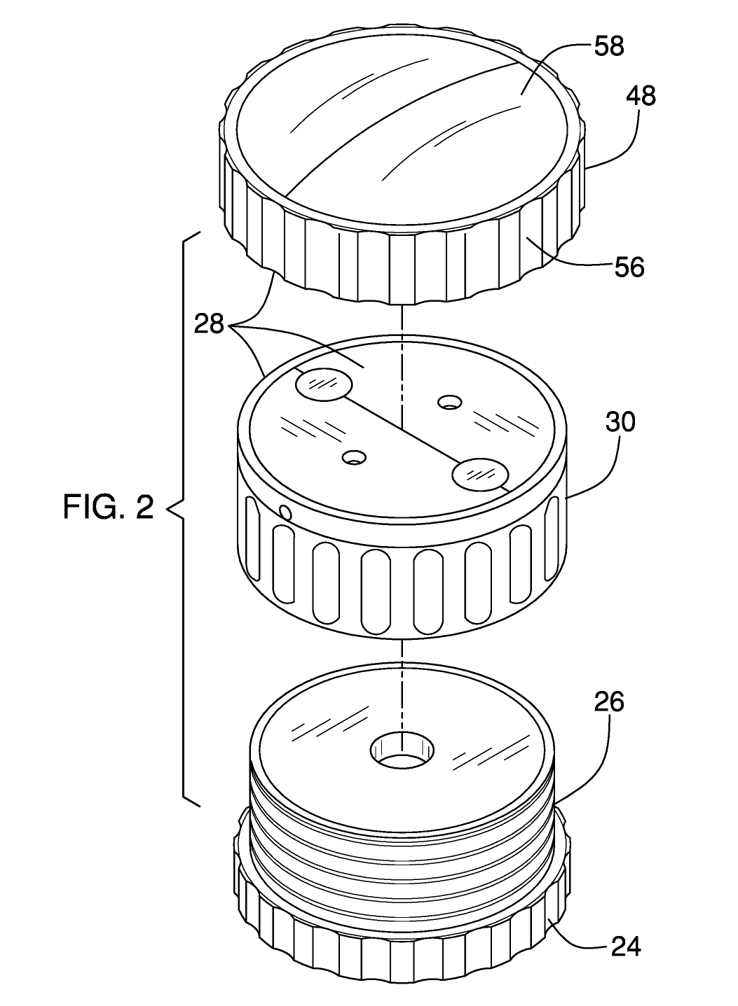

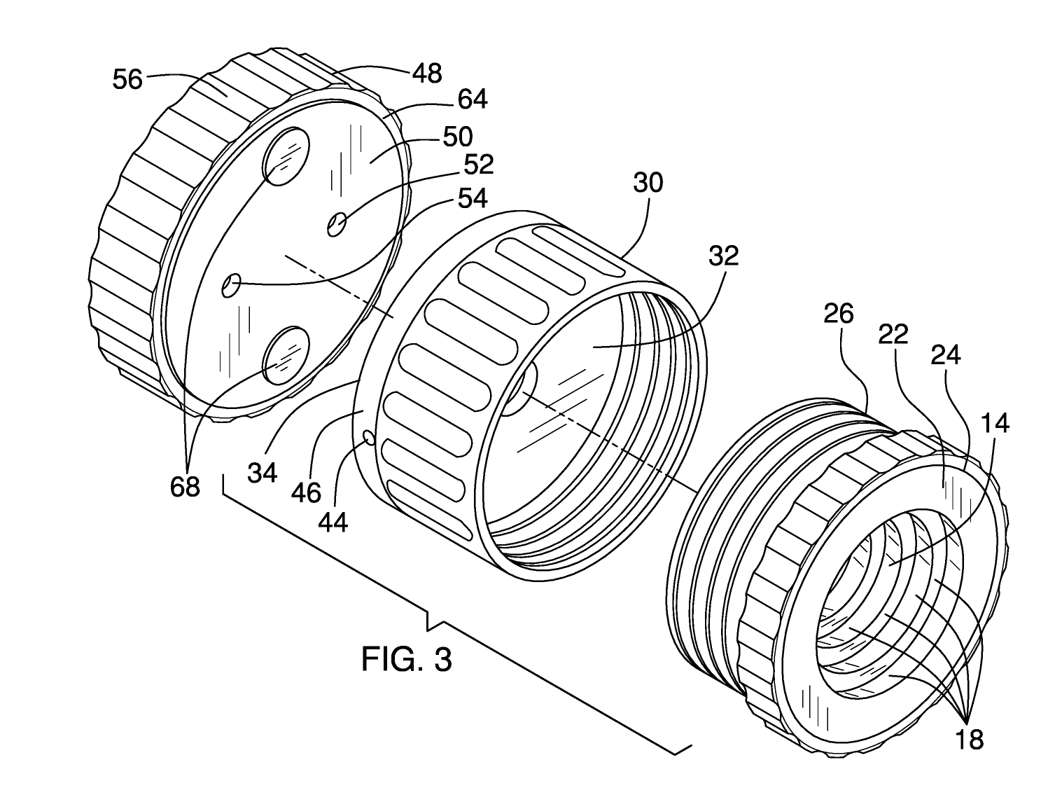

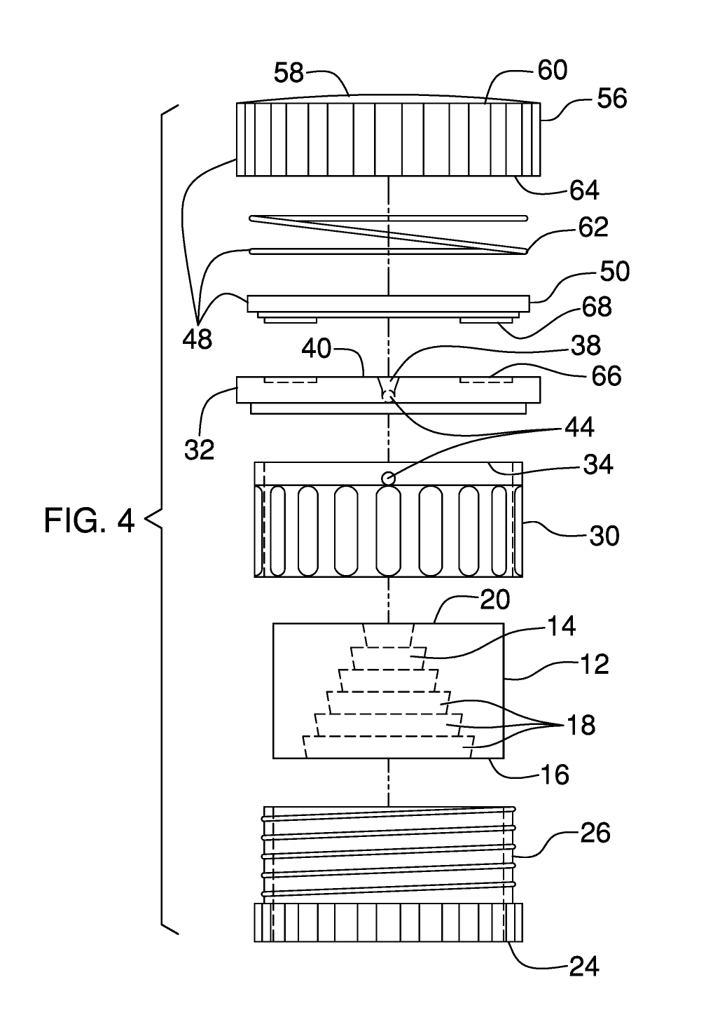

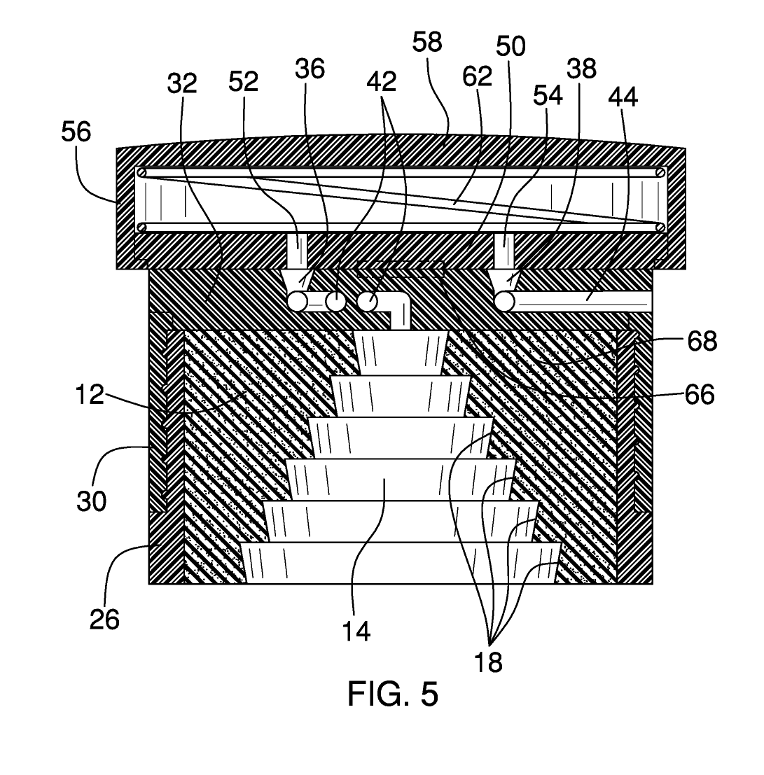

With reference now to the drawings, and in particular to FIGS. 1 through 5 thereof, a new closure assembly embodying the principles and concepts of an embodiment of the disclosure and generally designated by the reference numeral 10 will be described.

As best illustrated in FIGS. 1 through 5, the container closure assembly 10 generally comprises a cylinder 12 that is resilient. In one embodiment, the cylinder 12 comprises rubber. In another embodiment, the cylinder 12 comprises isobutylene isoprene rubber. A bore 14 is axially positioned through the cylinder 12. The bore 14 is tapered so that the bore 14 is circumferentially larger proximate to a bottom 16 of the cylinder 12. The bore 14 is configured to insert a mouth of a container. The cylinder 12 is configured to abut a lip of the container to sealably couple to the lip of the container.

In one embodiment, a plurality of insets 18 extends from the bore 14 into the cylinder 12. The plurality of insets 18 extends from the bottom 16 to proximate to a top 20 of the cylinder 12. The insets 18 are circumferentially smaller proximate to the top 20. Each inset 18 is configured to insert the mouth of a respective container that has the lip sized complementarily to the inset 18.

A rim 22 is coupled to a lower perimeter 24 of a first tube 26 and extends radially into the first tube 26. The first tube 26 is complementary to the cylinder 12. The first tube 26 is positioned to insert the cylinder 12 until the bottom 16 of the cylinder 12 abuts the rim 22. The first tube 26 is externally threaded.

A regulator 28 is selectively couplable to the top 20 of the cylinder 12. The regulator 28 is configured to selectively sealably close the bore 14 and to selectively motivate air through the bore 14. The regulator 28 is configured to extract the air through the bore 14 to partially evacuate the container to couple the cylinder 12 to the container. The regulator 28 also is configured to inject the air through the bore 14 to pressurize the container to decouple the cylinder 12 from the container.

In one embodiment, the regulator 28 comprises a second tube 30 that is complementary to the first tube 26. The second tube 30 is internally threaded. The second tube 30 is positioned to threadedly insert the first tube 26 to proximate to the lower perimeter 24 of the first tube 26 to couple the second tube 30 to the first tube 26. In another embodiment, the second tube 30 is externally textured and the first tube 26 is externally textured proximate to the lower perimeter 24 of the first tube 26. The first tube 26 and the second tube 30 are textured so that they are configured to prevent slippage of hands that grasp the first tube 26 and the second tube 30 and opposingly rotate the first tube 26 relative to the second tube 30 to selectively couple the second tube 30 to the first tube 26.

A disc 32 is positioned in, and is coupled to, an upper end 34 of the second tube 30. A first port 36 and a second port 38 are positioned in an upper surface 40 of the disc 32. A first channel 42 is positioned in the disc 32 and extends from the first port 36 to the bore 14. A second channel 44 is positioned in the disc 32 and extends from the second port 38 to a surface 46 of the second tube 30. The second port 38 is fluidically coupled to the atmosphere.

A pump 48 is selectively couplable to the second tube 30. The pump 48 comprises a piston 50. A first valve 52 and a second valve 54 are coupled to and positioned through the piston 50. The first valve 52 is configured to selectively permit entry of the air into the pump 48. The first valve 52 is selectively fluidically couplable to the first port 36 and the second port 38. The second valve 54 is configured to selectively permit exit of the air from the pump 48. The second valve 54 also is selectively fluidically couplable to the first port 36 and the second port 38. The first valve 52 is positioned to selectively align with the first port 36 concurrently with the second valve 54 being aligned with the second port 38. The first valve 52 also is positioned to selectively align with the second port 38 concurrently with the second valve 54 being aligned with the first port 36.

In one embodiment, the pump 48 comprises a third tube 56 that is selectively couplable to the second tube 30. In one embodiment, the third tube 56 is externally textured. The third tube 56 is textured so that the third tube 56 configured to prevent slippage of a hand that grasps the third tube 56 to selectively couple the third tube 56 to the second tube 30.

A panel 58 is coupled to an upper circumference 60 of the third tube 56. The panel 58 is resilient. A spring 62 is coupled to and extends between the panel 58 and the piston 50. The piston 50 is biased to a position proximate to a lower circumference 64 of the third tube 56. The third panel 58 is configured to be depressed to compress the spring 62. The spring 62 is configured to rebound to motivate the panel 58 distally from the piston 50.

A pair of first magnets 66 is coupled to the disc 32. A pair of second magnets 68 is coupled to the piston 50. Each second magnet 68 is alignably positioned with a respective first magnet 66. The second magnets 68 are opposingly polarized relative to the first magnets 66. Each second magnet 68 is positioned to selectively couple to the respective first magnet 66 to couple the piston 50 to the disc 32.

In use, the panel 58 is configured to be depressed to compress the spring 62 and to selectively compel the exit of the air from the pump 48 through the second valve 54. The spring 62 is configured to rebound to motivate the panel 58 distally from the piston 50 and to selectively compel the entry of the air into the pump 48 through the first valve 52. The pump 48 is selectively couplable to the second tube 30 so that the first valve 52 is positioned to selectively align with the first port 36 concurrently with the second valve 54 being aligned with the second port 38. The pump 48 is configured to selectively extract the air from the container through the bore 14, the first channel 42, the first port 36, and the first valve 52. The pump 48 also is configured to selectively compel the air through the second valve 54, the second port 38, and the second channel 44 to partially evacuate the container. The cylinder 12 is sealably coupled to the lip of the container.

The pump 48 also is selectively couplable to the second tube 30 so that the first valve 52 is positioned to selectively align with the second port 38 concurrently with the second valve 54 being aligned with the first port 36. The pump 48 is configured to selectively draw the air from the atmosphere through the second channel 44, the second port 38, and the first valve 52. The pump 48 is configured to selectively compel the air through the second valve 54, the first port 36, the first channel 42, and the bore 14 to pressurize the container to decouple the cylinder 12 from the container.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A container closure assembly comprising:
a cylinder, said cylinder being resilient;
a bore axially positioned through said cylinder, said bore being tapered such that said bore is circumferentially larger proximate to a bottom of said cylinder;
a regulator selectively couplable to a top of said cylinder, said regulator being configured for selectively sealably closing said bore and for selectively motivating air through said bore; and
wherein said bore is positioned through said cylinder such that said bore is configured for inserting a mouth of a container such that said cylinder is configured for abutting a lip of the container for sealably coupling to the lip of the container, wherein said regulator is positioned on said cylinder such that said regulator is configured for extracting the air through said bore for partially evacuating the container for coupling said cylinder to the container and for injecting the air through said bore for pressurizing the container for decoupling said cylinder from the container.

2. The assembly of claim 1, further including said cylinder comprising rubber.

3. The assembly of claim 2, further including said cylinder comprising isobutylene isoprene rubber.

4. The assembly of claim 1, further including a plurality of insets extending from said bore into said cylinder, said plurality of insets extending from said bottom to proximate to said top of said cylinder such that said insets are circumferentially smaller proximate to said top, wherein said insets are positioned in said cylinder such that each said inset is configured for inserting the mouth of a respective container having a lip sized complementarily to said inset.

5. The assembly of claim 1, further comprising:
a first tube complementary to said cylinder, said first tube being externally threaded;
a rim coupled to a lower perimeter of said first tube and extending radially into said first tube, wherein said rim is positioned on said first tube such that said first tube is positioned for inserting said cylinder such that said bottom of said cylinder abuts said rim;
said regulator comprising:
a second tube complementary to said first tube, said second tube being internally threaded such that said second tube is positioned for threadedly inserting said first tube to proximate to a lower perimeter of said first tube for coupling said second tube to said first tube,
a disc positioned in and coupled to an upper end of said second tube,
a first port and a second port positioned in an upper surface of said disc,
a first channel positioned in said disc, said first channel extending from said first port to said bore,
a second channel positioned in said disc, said second channel extending from said second port to a surface of said second tube such that said second port is fluidically coupled to the atmosphere,
a pump selectively couplable to said second tube, said pump comprising a piston,
a first valve coupled to and positioned through said piston, said first valve being configured for selectively permitting entering of the air into said pump, said first valve being selectively fluidically couplable to said first port and said second port,
a second valve coupled to and positioned through said piston, said second valve being configured for selectively permitting exiting of the air from said pump, said second valve being selectively fluidically couplable to said first port and said second port, and
wherein said first valve and said second valve are positioned in said piston such that said first valve is positioned for selectively aligning with said first port concurrently with said second valve aligning with said second port, and such that said first valve is positioned for selectively aligning with said second port concurrently with said second valve aligning with said first port; and
wherein said pump is selectively couplable to said second tube such that said first valve is positioned for selectively aligning with said first port concurrently with said second valve aligning with said second port such that said pump is configured for selectively extracting the air from the container through said bore, said first channel, said first port and said first valve and for selectively compelling the air through said second valve, said second port, and said second channel for partially evacuating the container such that said cylinder is sealably coupled to the lip of the container, and wherein said pump is selectively couplable to said second tube such that said first valve is positioned for selectively aligning with said second port concurrently with said second valve aligning with said first port such that said pump is configured for selectively drawing the air from the atmosphere through said second channel, said second port and said first valve and for selectively compelling the air through said second valve, said first port, said first channel, and said bore for pressurizing the container for decoupling said cylinder from the container.

6. The assembly of claim 5, further including comprising:
a pair of first magnets coupled to said disc;
a pair of second magnets coupled to said piston such that each said second magnet is alignably positioned with a respective said first magnet, said second magnets being opposingly polarized relative to said first magnets; and
wherein said second magnets are positioned in said piston such that each said second magnet is positioned for selectively coupling to said respective said first magnet for coupling said piston to said disc.

7. The assembly of claim 5, further including said second tube being externally textured, said first tube being externally textured proximate to said lower perimeter of said first tube, wherein said second tube and said first tube are externally textured such that said first tube and said second tube are configured for preventing slippage of hands grasping said first tube and said second tube and opposingly rotating said first tube relative to said second tube for selectively coupling said second tube to said first tube.

8. The assembly of claim 5, further including said pump comprising:
a third tube selectively couplable to said second tube;
a panel coupled to an upper circumference of said third tube, said panel being resilient;
a spring coupled to and extending between said panel and said piston such that said piston is biased to a position proximate to a lower circumference of said third tube; and
wherein said panel is positioned on said third tube such that said panel is configured for depressing for compressing said spring, wherein said spring is positioned on said piston and said panel such that said spring is configured for rebounding for motivating said panel distally from said piston.

9. The assembly of claim 8, further including said third tube being externally textured, wherein said third tube is externally textured such that said third tube is configured for preventing slippage of a hand grasping said third tube for selectively coupling said third tube to said second tube.

10. A container closure assembly comprising:
a cylinder, said cylinder being resilient, said cylinder comprising rubber, said cylinder comprising isobutylene isoprene rubber;
a bore axially positioned through said cylinder, said bore being tapered such that said bore is circumferentially larger proximate to a bottom of said cylinder, wherein said bore is positioned through said cylinder such that said bore is configured for inserting a mouth of a container such that said cylinder is configured for abutting a lip of the container for sealably coupling to the lip of the container;
a plurality of insets extending from said bore into said cylinder, said plurality of insets extending from said bottom to proximate to a top of said cylinder such that said insets are circumferentially smaller proximate to said top, wherein said insets are positioned in said cylinder such that each said inset is configured for inserting the mouth of a respective container having a lip sized complementarily to said inset;
a first tube complementary to said cylinder, said first tube being externally threaded;
a rim coupled to a lower perimeter of said first tube and extending radially into said first tube, wherein said rim is positioned on said first tube such that said first tube is positioned for inserting said cylinder such that said bottom of said cylinder abuts said rim;
a regulator selectively couplable to said top of said cylinder, said regulator being configured for selectively sealably closing said bore and for selectively motivating air through said bore, wherein said regulator is positioned on said cylinder such that said regulator is configured for extracting the air through said bore for partially evacuating the container for coupling said cylinder to the container and for injecting the air through said bore for pressurizing the container for decoupling said cylinder from the container, said regulator comprising:
a second tube complementary to said first tube, said second tube being internally threaded such that said second tube is positioned for threadedly inserting said first tube to proximate to a lower perimeter of said first tube for coupling said second tube to said first tube, said second tube being externally textured, said first tube being externally textured proximate to said lower perimeter of said first tube, wherein said second tube and said first tube are externally textured such that said first tube and said second tube are configured for preventing slippage of hands grasping said first tube and said second tube and opposingly rotating said first tube relative to said second tube for selectively coupling said second tube to said first tube,
a disc positioned in and coupled to an upper end of said second tube,
a first port and a second port positioned in an upper surface of said disc,
a first channel positioned in said disc, said first channel extending from said first port to said bore,
a second channel positioned in said disc, said second channel extending from said second port to a surface of said second tube such that said second port is fluidically coupled to the atmosphere,
a pair of first magnets coupled to said disc,
a pump selectively couplable to said second tube, said pump comprising:
a piston,
a third tube selectively couplable to said second tube, said third tube being externally textured, wherein said third tube is externally textured such that said third tube is configured for preventing slippage of a hand grasping said third tube for selectively coupling said third tube to said second tube,
a panel coupled to an upper circumference of said third tube, said panel being resilient,
a spring coupled to and extending between said panel and said piston such that said piston is biased to a position
proximate to a lower circumference of said third tube, and wherein said panel is positioned on said third tube such that said panel is configured for depressing for compressing said spring, wherein said spring is positioned on said piston and said panel such that said spring is configured for rebounding for motivating said panel distally from said piston,
a pair of second magnets coupled to said piston such that each said second magnet is alignably positioned with a respective said first magnet, said second magnets being opposingly polarized relative to said first magnets, wherein said second magnets are positioned in said piston such that each said second magnet is positioned for selectively coupling to said respective said first magnet for coupling said piston to said disc,
a first valve coupled to and positioned through said piston, said first valve being configured for selectively permitting entering of the air into said pump, said first valve being selectively fluidically couplable to said first port and said second port,
a second valve coupled to and positioned through said piston, said second valve being configured for selectively permitting exiting of the air from said pump, said second valve being selectively fluidically couplable to said first port and said second port, and
wherein said first valve and said second valve are positioned in said piston such that said first valve is positioned for selectively aligning with said first port concurrently with said second valve aligning with said second port, and such that said first valve is positioned for selectively aligning with said second port concurrently with said second valve aligning with said first port; and
wherein said panel is positioned on said third tube such that said panel is configured for depressing for compressing said spring and for selectively compelling exiting of the air from said pump through said second valve, wherein said spring is positioned on said piston and said panel such that said spring is configured for rebounding for motivating said panel distally from said piston and for selectively compelling entering of the air into said pump through said first valve, wherein said pump is selectively couplable to said second tube such that said first valve is positioned for selectively aligning with said first port concurrently with said second valve aligning with said second port such that said pump is configured for selectively extracting the air from the container through said bore, said first channel, said first port and said first valve and for selectively compelling the air through said second valve, said second port, and said second channel for partially evacuating the container such that said cylinder is sealably coupled to the lip of the container, and wherein said pump is selectively couplable to said second tube such that said first valve is positioned for selectively aligning with said second port concurrently with said second valve aligning with said first port such that said pump is configured for selectively drawing the air from the atmosphere through said second channel, said second port and said first valve and for selectively compelling the air through said second valve, said first port, said first channel, and said bore for pressurizing the container for decoupling said cylinder from the container.
